(19) United States
(12) Patent Application Publication
(10) Pub. No.: US 2017/0279744 A1
(43) Pub. Date: Sep. 28, 2017

(54) New Instant Messaging(IM) routing method and router

(71) Applicant: Beijing VRV Software Corporation Limited, Beijing (CN)

(72) Inventors: Hao Lin, Beijing (CN); Li Zhong, Beijing (CN); Yi Jiang, Beijing (CN); Jianbin Hu, Beijing (CN)

(21) Appl. No.: 15/308,738

(22) PCT Filed: Jul. 15, 2015
(86) PCT No.: PCT/MY2015/050072

§ 371 Date: Nov. 3, 2016

(30) Foreign Application Priority Data
May 11, 2015 (CN) 201510234444.6

(51) Int. Cl. H04L 12/58; H04L 12/733

(52) U.S. Cl. CPC H04L 51/04; H04L 45/20

(57) ABSTRACT

This invention discloses a new Instant Messaging(IM) routing method and routers, to manage IM servers and provide network addressing, utilizing a management module and a routing module. Among them, the management module is used to maintain the router's own information and the information of IM servers, comprising of:
(1) Unique identification Router ID(RID) for every IM router in the entire network,
(2) Information of one or multiple servers that every IM router manages,
(3) Unique identification Host ID(HID) of every IM server in the entire network,
   The routing module provides routing method to facilitate the connectivity and communication between the IM servers based on the identification HID and identification RID. The significance of this invention is: Establishes a new form of IM network architecture by utilizing routing method and routers, allowing private, public IM servers to achieve reliable connectivity and communication, so as to fulfill the IM need of different businesses or organizations in a complex network environment.

### CROSS-REFERENCE TO RELATED APPLICATIONS

This application is a Section 371 National Stage Application of International Application No. PCT/MY2015/050072, filed on 15 Jul. 2015, which has not yet published, and claims priority to Chinese Patent Application No. 201510234444.6, filed on 11 May 2015, which are incorporated by reference in their entirety.

### TECHNICAL FIELD

This invention is classified under information technology involving the network architecture, methodologies and technique of Instant Messaging(IM), and more specifically to offer its client the management, routing method and equipment to facilitate interconnectivity and communication of the IM servers among the institutions, enterprises or organizations, and public users.

### BACKGROUND ART

IM is a service on the mobile phones, tablet PCs and computers, to send and receive texts, pictures, audio clips, video clips via a network; it is one of the common and popular applications in the Internet.

With the current available IM applications, the concept, method and technology of Instant Messaging(IM) routing method and router mentioned above doesn't exist. For example, WeChat, QQ, MSN, Skype and Real time eXpert (RTX), their IM service network is on a flat structure, all servers connected to each other, mirror images, utilizing the data from the same database. For example, the “e-connect” application targets small and medium enterprises through its IM service platform, despite of the introduction of the primary and backup controllers to manage the servers, its main focus is to improve load balance, improve performance on IM service. Others, such as protocol conversion gateway, is to facilitate information exchange of different enterprises IM servers, considered as encapsulation and analysis of IM data.

### DISCLOSURE OF INVENTION

The purpose of this invention is to serve various institutions, enterprises or organizations and even individuals, providing a new routing method and equipment to facilitate interconnectivity and communication for private and public IM servers in the internet, enterprise intranet, cloud computing platform and various complex network environments. Utilizing this type of IM routers, they can deploy a routing service network to conduct network addressing, making IM servers from different domains to conduct network addressing, enable them to connect each other, and allow users from various enterprises and organizations to have the private and secure IM, simultaneously having the ability to connect IM with external users.

A new type of IM router as described in this invention, is used to manage IM servers and provide addressing, consisting of a management module and a routing module. Among them, the management module is used to maintain the router's own information and IM servers' information that it manages, including: (1) Unique identification Router ID(RID) for every router in the entire network, (2) Information of one or multiple servers that every router manages (3) Unique identification Host ID(HID) of every server in the entire network.

This invention discloses a new IM routing method and routers, to manage IM servers and provides addressing, formed by a management module and a routing module. Among them, the management module is used to maintain the router's own information and manage the information of IM servers' information, comprising :
(1) Unique identification RID for every router in the entire network,
(2) Information of one or multiple servers that every router manages,
(3) Unique identification HID of every server in the entire network;
   Routing module provides routing method to facilitate the connectivity and communication between the IM servers based on the identification HID and identification RID previously mentioned above.

Router's own information that maintained by the management module, is comprised of: router name, identification RID, description, network address, status, server identification HID list that it manages, neighbor router identification RID list, routing table and etc. By using the neighbor router identification RID list, the IM router identifies the neighbor router that is connected by network, so that it will send addressing request to its neighbor router if the target server HID is not in the server identification HID list that it manages.

Each IM router will manage one or multiple IM servers, the basic information of the IM servers is stored in the servers HID list of servers managed by the router, the main server identification information has HID, name, description, network address, and status.

Neighbor router is determined at deployment stage of IM router, when the router forwards the addressing request, the router that can be reached by one network hop from the source router is the neighbor router. When the routing service network adds a new IM router, the router will then be configured to have one or more neighbor routers.

Routing table is created upon the information exchange after IM router communicates with its neighbor routers, in order to acquire network address of an IM server, it should forward addressing request to a neighbor router.

IM servers provides IM service to users, it's configuration information comprising: name, identification HID, description, network address, status, associated router identification RID, connection relation table, user list and etc.

Connection relation table stores name, identification HID, network address, status and other information of other IM server that are connected to this IM server previously, thus the servers can interconnect and communicate without the need to go through IM router for addressing.

The detailed routing method is: when source IM server doesn't have the network address of the target server, the source server submits the target server identification HID to its associated source router and requests addressing; subsequently the source router will search the target server's network address in routing service network based on routing strategy; once destination router that manages target server receives the addressing request, it will send back the target server network address to the source router, subsequently the source router shall forward the network address to the source server; in the end, the source server will establish network connection with the target server using this network address.

The routing strategy used by IM router on addressing is comprised of maximum speed strategy and hop count control strategy; in which the maximum speed strategy is referred as the minimum time required for addressing process from router to another router; hop count control strategy is referred as the maximum hop count the router assigned to the addressing request while sending out, so that each time it passes through a router, hop count will reduce by 1, when the hop count is zero(0), addressing request will be discarded and IM router will send back a message of addressing failure.

### DESCRIPTION OF DRAWINGS AND PREFERRED EMBODIMENT FOR CARRYING OUT THE INVENTION

The following will further elaborate the appendix and detailed description:

FIG. 1: Structure diagram of the IM router.

FIG. 2: Logical deployment schematic of the invention—A new IM router.

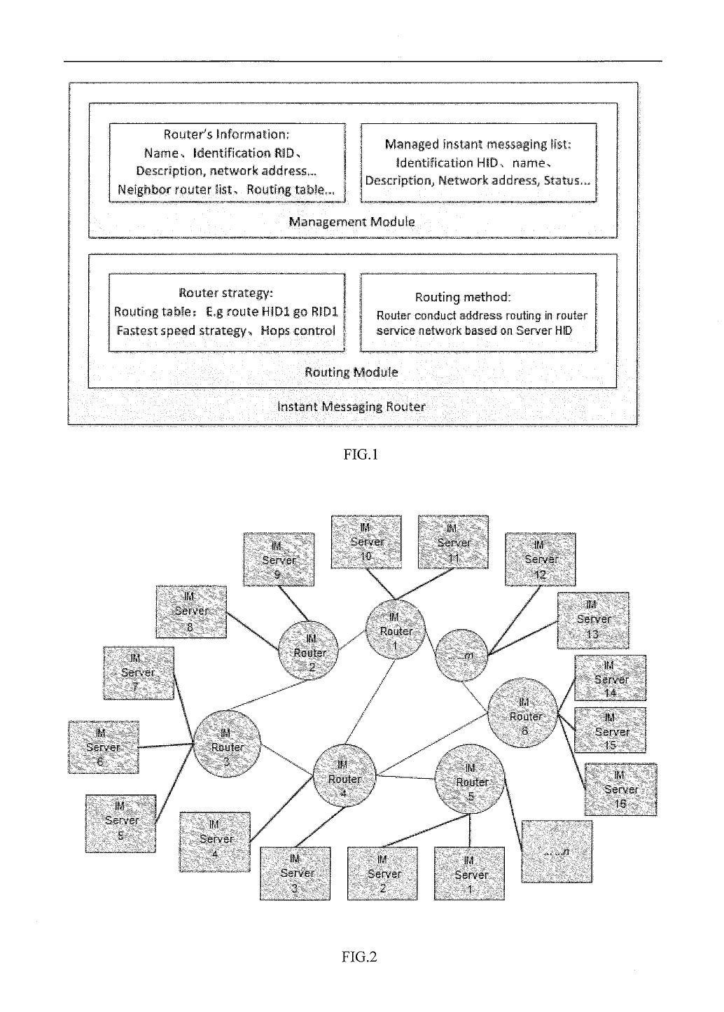

FIG. 1 is the structure diagram of the IM router.

This invention discloses a new IM routing method and routers, to manage IM servers and provides addressing, formed by a management module and a routing module. Among them, the management module is used to maintain the router's own information and the information of IM servers that it manages, comprising:
(1) Unique identification RID for every router in the entire network,
(2) Information of one or multiple servers that every router manages,
(3) Unique identification HID of every server in the entire network;
   Routing module provides routing method to facilitate the connectivity and communication between the IM servers based on the identification HID and identification RID previously mentioned above.

Router's own information that maintained by management module is comprised of: router name, identification RID, description, network address, status, server identification HID list that it manages, neighbor router identification RID list, routing table and etc. By using the neighbor router identification RID list, the IM router identifies the neighbor router that is connected to network, so that it will send addressing request to its neighbor router if the target server HID is not in the server identification HID list that it manages.

Each IM router will manage one or multiple IM servers, basic information is stored in these servers HID list of servers managed by the router, the main server identification information has HID, name, description, network address and status.

Neighbor router is determined at deployment stage of IM router, when the router forwards the addressing request, the router that can be reached by one network hop from the source routeris considered to be the neighbor router. When routing service network increases a new IM router, which will configure it to have one or more neighbor routers.

Routing table is created upon the information exchange after IM router communicating with its neighbor routers, in order to acquire network address of an IM server, the IM router should forward addressing request to a neighbor router.

IM servers provide IM service to users, it configures information comprising: name, identification HID, description, network address, status, associated router identification RID, connection relation table, user list and etc.

Connection relation table stores name, identification HID, network address, status and other information of other IM server that are previously connected to this IM server, thus the servers can interconnect and communicate without the need to go through IM router for addressing.

To define routing method: when one source IM doesn't have network address of a target server, the source server will submit the target server identification HID to its associated source router and request addressing; subsequently the source router will search the target server network address in routing service network based on routing strategy; once the destination router that manages the target server receives the addressing request, it will forward the target server network address to the source router, subsequently the source router shall forward the network address to the source server; in the end, the source server will establish network connection with the target server using this network address.

The routing strategy used by IM router on addressing comprising the maximum speed strategy and hop count control strategy; in which the maximum speed strategy referred as the minimum time required for addressing process from one router to another router; hop count control strategy referred as the maximum hop count the router assigned to the addressing request while sending out, so that each time it passes through a router, hop count will be reduced by 1, when the hop count is zero(0), addressing request will be discarded and a message of addressing failure will be sent back.

FIG. 2 is the Logical Deployment schematic of the invention—A new IM router. IM Router 1, 2, 3, 4, 5, 6 up to m form an IM router network, their Identifications are RID1, RID2, RID3, RID4, RID5, RID6 to RIDm; IM Server 1, 2, 3, 4, 5 to n formed IM service network, their identifications are HID1, HID2, HID3, HID4, HID5, to HIDn.

Each router will manage one or multiple servers, as indicated in FIG. 2, Router 1 manages Server 10 and 11, Router 2 manages Server 8 and 9, Router 3 manages Server 5, 6 and 7, Router 4 manages Server 3 and 4, Router 5 manages Server 1 and 2, Router 6 manages Server 14 and 15, and 16.

In the routing service network formed by routers, when the router forwards the addressing request, the router that can be reached by one network hop from the source router is the neighbor router. For example, neighbor routers of Router 1 are Router 2 and Router 4, neighbor routers of Router 2 are Router 1 and Router 3, neighbor routers of Router 3 are Router 2 and Router 4, neighbor routers of Router 4 are Router 1, Router 3, Router 5 and Router 6, neighbor router of Router 5 is only Router 4, neighbor router of Router 6 is Router 4,

Routing table is created upon the information exchange after one IM router communicates with its neighbor router. For example, in Router 3, it will create a route:

route HID8 go RID2

The meaning is: If searching for the network address of Server 8, the IM router should forward addressing request to Router 2.

Routing table of Route 3, will generate three routing table entries:

route HID9 go RID2
route HID3 go RID4
route HID4 go RID4

If Server 10 initiates an IM conversation, it is required to establish network connection with Server 3, then the addressing request will go from Router 1 to Router 4. There are 2 possible routes from Router 1 to Router 4:

(1) Router 1→2→3→4, assuming that it takes 1 second.
(2) Router 1→4, assuming that it takes 2 seconds.
If the Routing strategy is maximum speed strategy, then the addressing request from route(2) will be discarded.

For example, a typical group IM as example is used to elaborate the addressing process. Assuming user from Server 7 initiated a group IM, group users come from Servers 1, 6, 8, and 16, and the Server 16 is already in the connection relation table of Server 7. The addressing process is as follows:

(1) Server 7 first checks its connection relation table, identify Server 16 is in the table, then establishes network connection with Server 16 by using the network address of Server 16 from the connection relation table.

(2) Server 7 forwards addressing request to associated Router 3 for Servers 1, 6, and 8.

(3) Router 3 checks the server HID list that it manages, identify Server 6 in the listsends back the network address of Server 6 to Server 7, subsequently Server 7 establishes network connection with Sever 6.

(4) Router 3 checks the routing tablebased on “Route HID8 go RID2” and identifys that Router 2 knows the network address of Server 8, subsequently forwards the addressing request to Router 2.

(5) Router 2 receives addressing request for Server 8, checks its server HID list, sends back the network address of Server 8 to Router 3, subsequently Router 3 sends back the network address to Server 7, then Server 7 and Server 8 establish network connection.

(7) Router 3 still doesn't know the network address of Server 1, so according to the neighbor router's Identification RID list, forwards the addressing request of Server 1 to neighbor Router 2 and 4;

(8) Router 2 checks the server HID list and routing table and cannot identify the network address of Server 1, then continues to forward the addressing request to its neighbor Router 1.

(9) Router 4 will check the server HID list that it manages and can't find Server 1, but when it checks its routing table and finds “Route HID1 go RID5”, knowing that Router 5 has the network address of Server 1, thus forwards the network addressing request to Router 5.

(10) Router 5 receives network addressing request for Server 1, checks the server HID list that it manages, sends back the network address of Server 1 to Router 4, subsequently Router 4 forwards the network address to Router 3, then Router 3 sends back the network address to Server 7, Server 7 establishes network connection with Server 1.

(11) At this point, Server 7 has found all relevant servers' network address for the group message, addressing is completed.

We further elaborate on step eight (8), Router 1 still does not know the network address of Server 1, so it will continues to forward addressing request to its neighbor Router 4; we can see that from Router 3 to Router 4, there is 2 possible routes: Assuming address “Router 3→Router 4” takes shortest time to deliver the addressing request, then based on the maximum speed strategy, the addressing request from “Router 3→Router 2→Router 1→Router 4” will be discarded.

Network addressing request sent from the router has hop count parameters, effective preventing packet storm in routing service network, ensuring addressing efficiency.

As shown in FIG. 2, assuming IM Server 6 and 7 are public IM servers targeting public users, Server 8 and 9 are enterprise IM servers, Server 1 and 2 are IM servers belonging to an organization; these public users, enterprises or organizations users can have the advantage of using their own respective public or private IM servers to interconnect and connect IM.

1. A new Instant Messaging(IM) router comprises a management module and a routing module, which is characterized as:
The management module is used to maintain the router's own information and the IM server information that it manages, which is mainly consisted of:
(1) Unique identification Router ID(RID) for every IM router in the entire network,
(2) Information of one or multiple servers that every IM router manages,
(3) Unique identification Host ID(HID) of every server in the entire network;
Routing module provides routing method to facilitate the connectivity and communication between the IM servers based on the identification HID and identification RID.

2. The new Instant Messaging(IM) router of claim 1, wherein the Router's own information comprising: identification RID, description, network address, status, list of the server HID it managed list of neighbor router identification RID and routing table.

3. The new Instant Messaging(IM) router of claim 2, wherein the list of the server HID comprising: server identification HID, name, description, network address, and status.

4. The new Instant Messaging(IM) router of claim 2, wherein the features of the Neighbor router are: the neighbor router is determined at deployment stage of the IM router, when a source router forwards an addressing request, the router that can be reached by one network hop from the source router is considered to be the neighbor router.

5. The new Instant Messaging(IM) router of claim 2, wherein the features of the Routing table are: the routing table is created upon the information exchange after the IM router communicates with a neighbor router, in order to acquire network address of IM servers, it shall forward an addressing request to the neighbor router.

6. The new Instant Messaging(IM) router of claim 1, wherein the IM server information comprising: name, identification HID, description, network address, status, associated router identification RID, connection relation table, user list.

7. The new Instant Messaging(IM) router of claim 6, wherein the connection relation table comprising: table stores name, identification HID, network address, status and information of other IM server that are previously connected to this IM server; thus the servers can interconnect and communicate without the need to go through the IM router for addressing.

8. The new Instant Messaging(IM) router of claim 7, wherein the addressing features:
a source server submits a target server identification HID to associated source router and requests addressing; subsequently the source router will search a target server network address in routing service network based on a routing strategy;
once a destination router that manages the target server receives the addressing request, it will send back the target server network address to the source router, subsequently the source router shall forward the network address to the source server; in the end, the source server will establish network connection with the target server using this network address.

9. The new Instant Messaging(IM) router of claim 8, wherein the routing strategy execute maximum speed strategy and hop count control strategy; in which maximum speed strategy is referred as the minimum time required for addressing process from router to another router; hop count control strategy is referred as the maximum hop count the router assigned to the addressing request while sending out, so that each time it passes through a router, hop count will reduce by 1, when the hop count is zero(0), addressing request will be discarded and IM router will send back a message of addressing failure.
